(19) United States
(12) Patent Application Publication
(10) Pub. No.: US 2022/0114689 A1
(43) Pub. Date: Apr. 14, 2022

(54) SYSTEMS AND METHODS FOR CALCULATING CAPACITY OF A DISTRIBUTION CENTER

(71) Applicant: Walmart Apollo, LLC, Bentonville, AR (US)

(72) Inventors: Adam L. Cline, Bentonville, AR (US); Willie Montgomery, III, Rogers, AR (US); Zhuofei Li, Rogers, AR (US)

(21) Appl. No.: 17/070,450

(22) Filed: Oct. 14, 2020

(51) Int. Cl. G06Q 50/28; G06Q 10/06

(52) U.S. Cl. CPC G06Q 50/28; G06Q 10/06315; G06Q 10/06393

(57) ABSTRACT

In some embodiments, apparatuses and methods are provided herein useful to calculating a capacity of a distribution center. In some embodiments, a system for calculating a capacity of a distribution center comprises input systems configured to collect metrics for the distribution center, a performance database including the metrics, and a control circuit configured to receive, from the performance database, the metrics, calculate, based on the metrics, a cases per hour (CPH) value for the distribution center, determine, based on the metrics, a shift length (SL) value for the distribution center, calculate, based on the metrics, a head count (HC) value for the distribution center, calculate, based on the CPH value, SL value and HC value, the capacity of the distribution center, wherein the capacity of the distribution center is a volume that the distribution center is capable of handling, and publish the capacity of the distribution center.

### TECHNICAL FIELD

This invention relates generally to supply chains and, more specifically, the capacity of entities in a supply chain.

### BACKGROUND

At a high level, a supply chain typically comprises suppliers and/or manufacturers, distribution centers, and retail facilities. The suppliers and/or manufacturers provide goods to the distribution center, and the distribution center processes the goods for transport to the retail facilities. In some instances, demand is driven by the retail facilities. That is, the distribution center has a surplus of goods and seeks to keep up with the demands of the retail facilities. Human labor is a component of processing goods in a distribution center. Accordingly, distribution centers alter the quantity of human labor via scheduling of employees to match the demand of the retail facilities.

Distribution centers alter the quantity of human labor based on expected demands of the retail facilities and the throughput capabilities of the distribution center. However, the throughput capabilities of the distribution center are typically estimated by hand based on the guesses, assumptions, and beliefs of the those making the estimates. As can be expected, these throughput capability estimates are prone to significant error. Accordingly, a need exists for systems, methods, and apparatuses that can be used to more accurately calculate the throughput capabilities of a distribution center.

### BRIEF DESCRIPTION OF THE DRAWINGS

Disclosed herein are embodiments of systems, apparatuses, and methods pertaining to calculating a capacity of a distribution center. This description includes drawings, wherein:

FIG. 1 depicts a distribution center 102 receiving and shipping products, according to some embodiments;

FIG. 2 is a block diagram of a system 200 for calculating a capacity of a distribution center, according to some embodiments;

FIG. 3 is a flow chart depicting example operation for calculating a capacity of distribution center, according to some embodiments;

FIG. 4 depicts a capacity calculation data flow 400, according to some embodiments; and

FIG. 5 is a block diagram of a system 500 that may be used for implementing any of the components, circuits, circuitry, systems, functionality, apparatuses, processes, or devices of the system 200 of FIG. 2, and/or other above or below mentioned systems or devices, or parts of such circuits, circuitry, functionality, systems, apparatuses, processes, or devices.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to calculating the capacity of a distribution center. In some embodiments, a system for calculating a capacity of a distribution center comprises input systems, wherein the input systems collect metrics for the distribution center, a performance database coupled to the input systems, wherein the performance database includes the metrics for the distribution center, and a control circuit, wherein the control circuit is communicatively coupled to the performance database, and wherein the control circuit is configured to receive, from the performance database, the metrics for the distribution center, calculate, based on the metrics for the distribution center, a cases per hour (CPH) value for the distribution center, wherein the CPH value is indicative of a number of cases that is historically handled by the distribution center, determine, based on the metrics for the distribution center, a shift length (SL) value for the distribution center, wherein the SL value is indicative of a number of hours that employees work at the distribution center, calculate, based on the metrics for the distribution center, a head count (HC) value for the distribution center, wherein the HC value is indicative of a number of employees working at the distribution center, calculate, based on the CPH value, SL value and HC value, the capacity of the distribution center, wherein the capacity of the distribution center is a volume that the distribution center is capable of handling, and publish, to an external system, the capacity of the distribution center.

As previously discussed, distribution centers are part of a supply chain. The distribution centers receive goods from suppliers and/or manufacturers, and process the goods for transport to retail facilities. For example, employees of a distribution center can process cases of goods for transport to the retail facilities. Accordingly, the throughput capabilities of the distribution center is based on the quantity of goods that the employees of the distribution center can process.

In some instances, demand at the distribution center is driven by the retail facilities. That is, the distribution center possesses a surplus of goods and reacts to the demand of retail facilities by processing the goods for transport to the retail facilities. Accordingly, the limiting factor for providing goods to the retail facilities, in some circumstances, is human labor. Because human labor is often a significant cost for the distribution center, it is beneficial to match the human labor of the distribution center with the demand of the retail facilities.

Typically, the demand of the retail facilities is known. For example, the demand for the retail facilities can be forecast based on historical data and/or demand can be based on recent sales (e.g., retail facilities know how many of each product was sold in the last week and ask for their next fulfilments to replenish the sold products). The capacity of the distribution center (i.e., the distribution center's ability to process goods), however, is more difficult to determine. Currently, the throughput capabilities of a distribution center are estimated by a human employee. The human employee, for example a manager of the distribution center, estimates the throughput capabilities of the distribution center based on his or her experiences in the distribution center. This estimate, however, is prone to error, as it is based on guesses, assumptions, and beliefs of the human employee making the estimate.

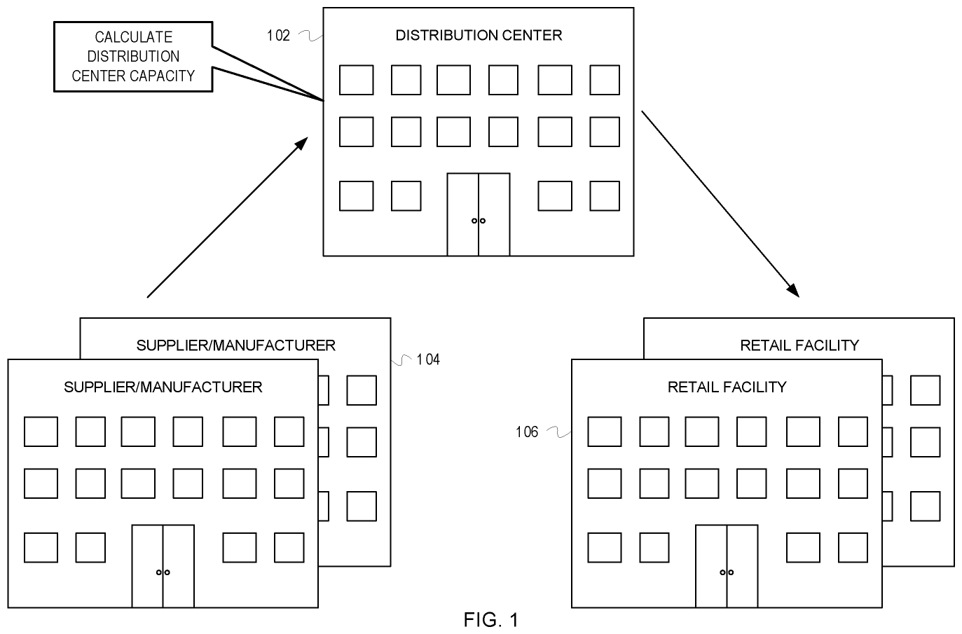

Disclosed herein are systems, methods, and apparatuses that seek to provide capacity values for distribution centers that are more accurate than those throughput estimates made by human employees. For example, in one embodiment, the systems, methods, and apparatuses described herein calculate a capacity for a distribution center based on data provided by input systems. As one example, the capacity calculation can consider input data for a previous time period to formulate a capacity for the distribution center. The capacity for the distribution center can then be used in scheduling decisions for employees of the distribution center based on actual and/or estimated demand. The discussion of FIG. 1 provides an overview of a such a system.

FIG. 1 depicts a distribution center 102 receiving and shipping products, according to some embodiments. The distribution center 102 receives goods from suppliers and/or manufacturers (generally referred to as “suppliers” 104). The distribution center 102 processes the goods received from the suppliers 104. For example, the suppliers 104 may ship the goods to the distribution center 102 in large quantities, such as on a pallet. Each pallet contains a number of cases (e.g., a warehouse pack of an item). The distribution center 102 processes the goods by unloading the pallets from transport vehicles (e.g., trucks, trains, and/or aircraft), storing the pallets, and removing cases from the pallets for smaller shipments to retail facilities 106.

A number of employees work at the distribution center 102. Additionally, in some embodiments, automated devices (e.g., robots) may work alongside the employees. The employees, and possibly automated devices, process the goods that arrive at the distribution center. Because the goods are processed at least partially by employees, the quantity of goods (e.g., the number of cases) that can be processed by the distribution center is dependent upon the number of employees working at the distribution center 102. Because employees represent a not insignificant cost for the distribution center 102, it is desirable to schedule only as many employees as needed to keep up with the demand of the retail facilities 106. Additionally, it is desirable to schedule a sufficient number of employees to handle the demand of the retail facilities.

In an effort to schedule an appropriate number of employees based on the demand of the retail facilities 106, a capacity of the distribution center 102 is calculated. The capacity of the distribution center 102 can be a volume that the distribution center 102 is capable of handling. For example, the capacity of the distribution center 102 can be a number of cases that the distribution center 102 can process. As previously noted, the capacity of the distribution center is based, at least in part, on human labor. For example, the capacity of the distribution center 102 is directly proportional to the number of employees working at the distribution center 102 and the number of hours worked by the employees at the distribution center. In one embodiment, a calculation for the capacity of the distribution center 102 considers both of these values. In such embodiments, a head count (“HC”) value is indicative of a number of employees working at the distribution center 102. The HC value may include not only those employees that are assigned to the distribution center 102, but also those employees assigned to different distribution centers but are working at the distribution center 102 (e.g., employees that are “loaned” to the distribution center 102). A shift length (“SL”) value is indicative of a number of hours that employees work in the distribution center 102.

In addition to the HC value and SL value, in one embodiment, the capacity calculation also considers a cases per hour (“CPH”) value. The CPH value is indicative of a number of cases that is historically handled by the distribution center. In such embodiments, the capacity of the distribution center 102 is calculated according to a formula,

Capacity=CPH value×SL value×HC value,

wherein the CPH value is the number of cases per hour and has units of cases per hour, the SL value is the shift length and has units of hours, and the HC value is a head count and is unitless. Accordingly, the value for Capacity has a unit of cases. Because the capacity of the distribution center 102 is based on historical and/or estimated data for head count, shift length, and cases per hour, the calculated capacity of the distribution center 102 can be much more accurate than the estimates the currently exist. Further, the capacity is calculated, as opposed to estimated. In some embodiments, this accuracy is improved by using a large data set (e.g., a data set including a greater number of data than could be considered by a human) over a period of time, such as average values over a period of time. The period of time can be any suitable value, such as a number of weeks (e.g., one week), months (e.g., six months), or years (e.g., one year). Further, in one embodiment, the data can be refreshed on a regular basis in a first in/first out basis. For example, if the time period is twenty-six weeks, the data capacity calculation can be recalculated once every week using data from the immediately previous twenty-six weeks.

The capacity of the distribution center 102 can be used in a variety of ways. For example, the capacity of the distribution center can be used to determine a number of employees to schedule, plan for anticipated employee absences (e.g., holidays, sick days, paid time off, etc.), generate alerts if the capacity of the distribution center does not match the known or forecast demand, etc. Additionally, though the discussion thus far has referred to capacity as a measurement of the number of cases that the distribution center 102 can process for shipment to the retail facilities 106, embodiments are not so limited. For example, similar calculations can be performed on the inbound side of the distribution center 102 to determine the capacity of the distribution center with respect to the receipt of shipments from the suppliers 104. Such calculations can be used to plan for deliveries, throttle deliveries, reschedule deliveries, etc.

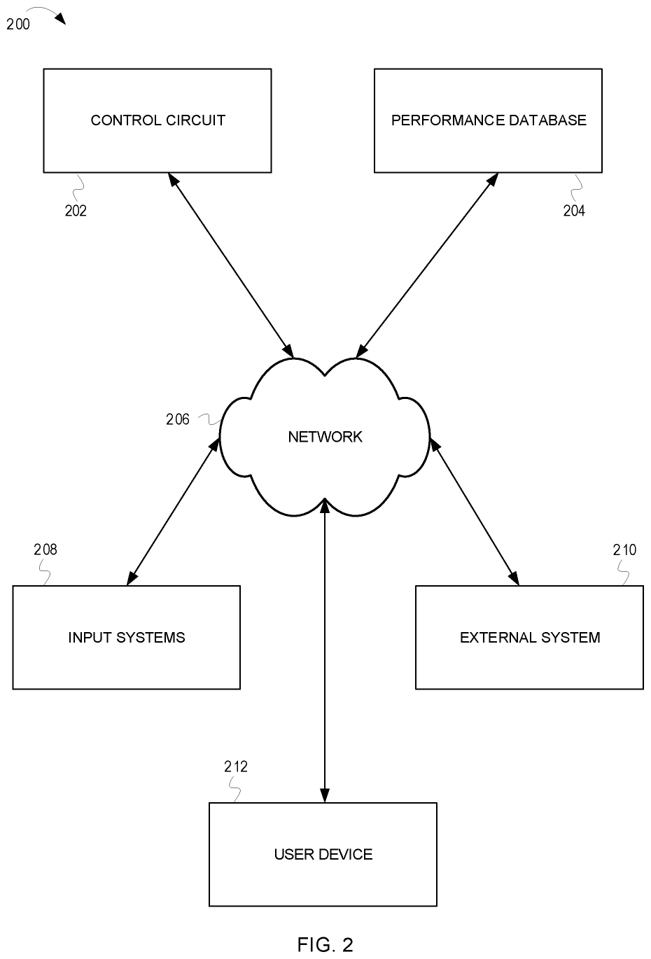

While the discussion of FIG. 1 provides an overview of calculating the capacity of a distribution center, the discussion of FIG. 2 provides additional detail regarding a system for calculating the capacity of a distribution center.

FIG. 2 is a block diagram of a system 200 for calculating a capacity of a distribution center, according to some embodiments. The system 200 includes a control circuit 202, a performance database 204, a network 206, input systems 208, external systems 210, and a user device 212 (e.g., a smartphone, laptop computer, desktop computer, tablet computer, device dedicated to distribution center tasks, etc.). One or more of the control circuit 202, performance database, 204, input systems 208, external systems 210, and user device 212 are communicatively coupled via the network 206. The network 206 can be of any suitable type and include a local area network (LAN) and/or wide area network (WAN), such as the Internet. Accordingly, the network 206 can include wired and/or wireless links.

The input systems 208 collect metrics for the distribution center. The metrics for the distribution center can include employee clock-in/clock-out information, employee availability information, business rules for employees (e.g., numbers of hours employees can work, recognized holidays, hours available based on days of the week), historical shipment information (both inbound to, and outbound from, the distribution center), scheduled shipment information (i.e., both inbound to, and outbound from, the distribution center), product information (e.g., number of cases on a pallet, number of selling units in a case, etc.), etc. Accordingly, the input systems 208 can be multiple systems or a single system that aggregates data from multiple systems. The multiple systems can include employee timecard systems, scheduling systems, team performance systems, warehouse management systems, yard management systems, global reporting systems, manual reporting systems, etc. Additionally, in some embodiments, the input systems 208 can include handheld devices (i.e., devices carried by users). For example, the input systems 208 can include, and/or receive data from, the user device 212 as well as other devices, such as handheld devices dedicated to work in a distribution center, head mounted systems, etc. For example, employees can use the handheld devices to receive work tasks (e.g., instructions for which pallets to process, products to unload, etc.) and input task completion information (e.g., confirm picks, enter pick quantities, etc.).

The performance database 204 stores the metrics for the database. Accordingly, the performance database 204 can take any suitable and/or comprise any desired number of databases. For example, the performance database 204 can be a relational database, a NoSQL database, etc.

The control circuit 202 generally process the metrics from the performance database 204 (e.g., by performing calculations and making determinations with respect to the metrics) and calculates the capacity of the distribution center. The control circuit 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 202 is configured (for example, by using corresponding programming as will be well understood by those skilled in the art) to carry out one or more of the steps, actions, and/or functions described herein.

By one optional approach the control circuit 202 operably couples to a memory. The memory may be integral to the control circuit 202 or can be physically discrete (in whole or in part) from the control circuit 202 as desired. This memory can also be local with respect to the control circuit 202 (where, for example, both share a common circuit board, chassis, power supply, and/or housing) or can be partially or wholly remote with respect to the control circuit 202 (where, for example, the memory is physically located in another facility, metropolitan area, or even country as compared to the control circuit 202).

This memory can serve, for example, to non-transitorily store the computer instructions that, when executed by the control circuit 202, cause the control circuit 202 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

In one embodiment, the control circuit 202 calculates the capacity of a distribution center based on a CPH value, SL value, and HC value for the distribution center. The CPH value is indicative of a number of cases per hour that is historically handled by the distribution center. For example, the number of cases can include those cases that are processed by employees for transport to a retail facility. The CPH value can be based on historical data (i.e., metrics for the distribution center) stored in the performance database 204. The historical data used by the control circuit 202 to calculate the CPH value can cover any desired time period, such as a number of days, weeks, months, or years. In one embodiment, the cases per hour value is based on the total cases and the total hours. In such embodiments, the cases per hour value is calculated according to a formula,

$$C P H = \frac{total cases}{total hours} ,$$

wherein CPH is the cases per hour value in units of cases per hour, total cases is the number of cases in units of cases, and total hours is the number of hours in units of hours. As previously noted, the CPH value can cover any desired time period and thus, the number of cases and the number of hours can reflect that time period. For example, the number of cases can be those cases processed in the last twenty-six weeks and the number of hours can be those hours worked in the last twenty-six weeks.

The control circuit 202 determines the SL value. The SL value is indicative of a number of hours that employees work at the distribution center. In some embodiments, the SL value is not a calculated value. Rather, the SL value is a business input. The SL value can be based on any suitable qualities, such as a day of the week, holidays, seasonal demand, a category of employee, etc. For example, the SL value can vary based on the day of the week and the type of employee, in which full time employees work nine hours on weekdays and ten hours on weekends, and where seasonal employees work ten hours on weekdays and eleven hours on weekends. In some embodiments, the SL value can be a value of expected hours worked given the qualities. In such embodiments, the calculation of the capacity of the distribution center is forward-looking based on the expected SL value.

Alternatively, in some embodiments, the control circuit can calculate the SL value. In such embodiments, the SL value can be a historical SL value, based on any desired time period. That is, the SL value can be a historical value that is backward-looking and used to calculate a future expected capacity of the distribution center. The historical SL value is calculated to according to a formula,

$$Hist SL = \frac{total hours}{total associates actually worked} ,$$

wherein, Hist SL is the historical SL value in units of hours, total hours is the number of hours worked in the units of hours, and total associates actually worked is the number of employees that worked in the distribution center and is unitless. As previously noted, the SL value can cover any desired time period and thus, the total hours and the total associates actually worked can reflect that time period. For example, the total hours can be those hours worked in the last twenty-six weeks and the total associates actually worked can be those associates that worked in the last twenty-six weeks.

The control circuit 202 calculates the HC value. The HC value is indicative of a number of employees working at the distribution center. Like the SL value, the HC value can be forward-looking (e.g., based on an expected number of employees that will be working in the distribution center) or backward-looking (e.g., based on a historical number of employees that worked in the distribution center). In the forward-looking approach, the HC value can be a business input based on the number, type, etc. of employees scheduled to work. In the backward-looking approach, the HC value is a calculation that describes the number of employees that have worked in the distribution center historically. Such backward-looking approaches can account for the number of employees that worked versus the number of employees scheduled (e.g., discrepancies based on absences from work). In such embodiments, the HC value is a historical HC value. The historical HC value is calculated according to a formula,

$$Hist HC = \frac{total hours}{hist SL} ,$$

wherein, Hist HC is the historical HC value and is unitless, total hours is the number of hours worked in the units of hours, and hist SL is the historical SL value in the units of hours. As previously noted, the HC value can cover any desired time period and thus, the total hours and the historical SL value can reflect that time period. For example, the total hours can be those hours worked in the last twenty-six weeks and the historical SL value can be the shift length for the last twenty-six weeks.

The control circuit 202 calculates the capacity of the distribution center based on the CPH value, the SL value, and the HC value. The control circuit 202 calculates the capacity of the distribution center according to a formula,

Capacity=CPH value×SL value×HC value,

wherein the CPH value is the number of cases per hour and has units of cases per hour, the SL value is the shift length and has units of hours, and the HC value is a head count and is unitless. Accordingly, the value for Capacity has a unit of cases. As the SL value and/or HC value can be forward-looking or backward-looking, the capacity of the distribution center can be calculated based on an expected SL value and HC value and/or a historical SL value and historical HC value.

After calculating the capacity for the distribution center, the control circuit 202 publishes the capacity of the distribution center to the external systems 210. The external systems can be those systems that are associated with the distribution center and/or systems associated with other entities, such as manufacturers, suppliers, retail facilities, etc. The control circuit 202 can publish the capacity of the distribution center to the external systems 210 by simply transmitting the capacity of the distribution center to the external systems 210. The external systems 210 can be used to generate tasks and/or actions for the distribution center and/or other entities. For example, the external systems 210 can include a scheduling tool. The scheduling tool can use the capacity to generate, or make recommendations for, an employee schedule.

In some embodiments, the control circuit 202 can analyze the capacity of the distribution center with respect to demands, for example, of one or more retail facilities. For example, the control circuit can receive an indication of an expected demand from one or more of the external systems 210. In such embodiments, the control circuit can make determinations regarding the anticipated demand based on the capacity of the distribution center. If the control circuit 202 determines that the anticipated demand cannot be met (i.e., the anticipated demand exceeds the capacity of the distribution center), the control circuit 202 can cause transmission of a notification indicating that the anticipated demand cannot be met. Additionally, in some embodiments, the control circuit can determine that the capacity of the distribution center exceeds the expected demand. In such embodiments, the control circuit 202 can cause relevant notifications to be transmitted. The notifications can be transmitted to the external systems 210 and/or the user device 212.

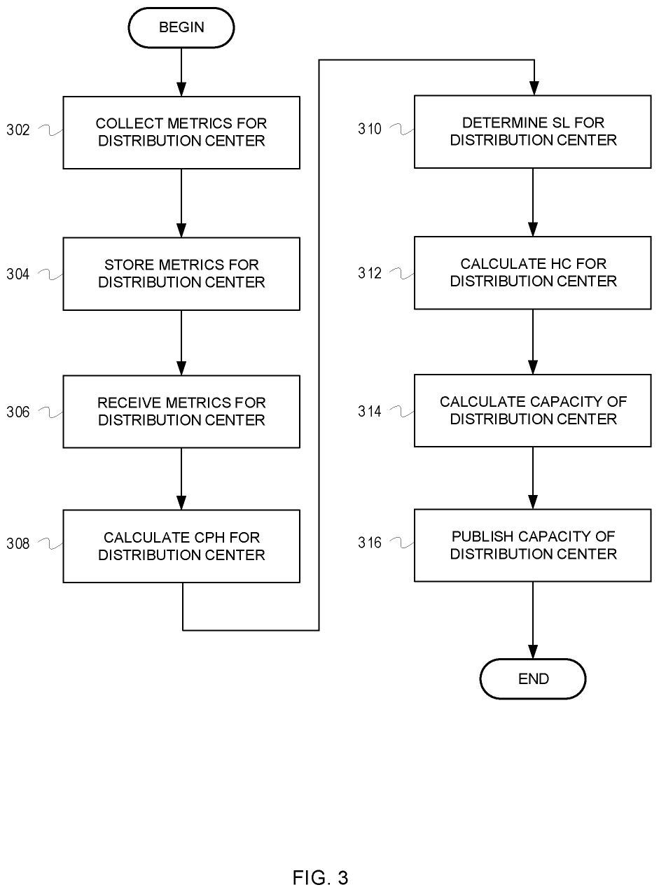

While the discussion of FIG. 2 provides additional detail regarding calculating the capacity of a distribution center, the discussion of FIG. 3 describes example operations for calculating the capacity of a distribution center.

FIG. 3 is a flow chart depicting example operation for calculating a capacity of distribution center, according to some embodiments. The flow begins at block 302.

At block 302, metrics for a distribution center are collected. For example, input systems can collect the metrics for the distribution center. The metrics for the distribution center can include employee clock-in/clock-out information, clock hours, employee availability information, employee hours, cases, employee hours, business rules for employees (e.g., numbers of hours employees can work, recognized holidays, hours available based on days of the week), historical shipment information (both inbound to, and outbound from, the distribution center), scheduled shipment information (i.e., both inbound to, and outbound from, the distribution center), product information (e.g., number of cases on a pallet, number of selling units in a case, etc.), etc. Accordingly, the input systems can be multiple systems or a single system that aggregates data from multiple systems. The flow continues at block 304.

At block 304, the metrics for the distribution center are stored. For example, a performance database can store the metrics for the distribution center. The performance database can be one or more databases that are communicatively coupled to the input systems. The flow continues at block 306.

At block 306, the metrics for the distribution center are received. For example, the metrics for the distribution center can be received by a control circuit from the performance database. The control circuit can receive the metrics for distribution center via a network. The flow continues at block 308.

At block 308, a CPH value for the distribution center is calculated. For example, the control circuit can calculate the CPH value for the distribution center. The CPH value is indicative of a number of cases per hour that is historically handled by the distribution center. For example, the number of cases can include those cases that are processed by employees for transport to a retail facility. The CPH value can be based on historical data (i.e., metrics for the distribution center) stored in the performance database. The historical data used by the control circuit to calculate the CPH value can cover any desired time period, such as a number of days, weeks, months, or years. In one embodiment, the cases per hour value is based on the total cases and the total hours. The flow continues at block 310.

At block 310, an SL value for the distribution center is determined. For example, the control circuit can determine the SL value for the distribution center. The SL value can be a business input or a calculated value. In either case, the control circuit determines the SL value. The SL value is indicative of a number of hours that employees work at the distribution center. The flow continues at block 312.

At block 312, an HC value for the distribution center is calculated. For example, the control circuit can calculate the HC value for the distribution center. The HC value is indicative of a number of employees working at the distribution center. Like the SL value, the HC value can be forward-looking (e.g., based on an expected number of employees that will be working in the distribution center) or backward-looking (e.g., based on a historical number of employees that worked in the distribution center). In the forward-looking approach, the HC value can be a business input based on the number, type, etc. of employees scheduled to work. In the backward-looking approach, the HC value is a calculation that describes the number of employees that have worked in the distribution center historically. Such backward-looking approaches can account for the number of employees that worked versus the number of employees scheduled (e.g., discrepancies based on absences from work). In such embodiments, the HC value is a historical HC value. The flow continues at block 314.

At block 314, the capacity of the distribution center is calculated. For example, the control circuit can calculate the capacity of the distribution center. The control circuit calculates the capacity of the distribution center based on the CPH value, the SL value, and the HC value. The flow continues at block 316.

At block 316, the capacity of the distribution center is published. For example, the control circuit can cause the capacity of the distribution center to be published. The control circuit can cause the capacity of the distribution center to be published to any suitable system and/or devices. For example, the control circuit can cause the capacity of the distribution center to be published to a mobile device and/or external systems.

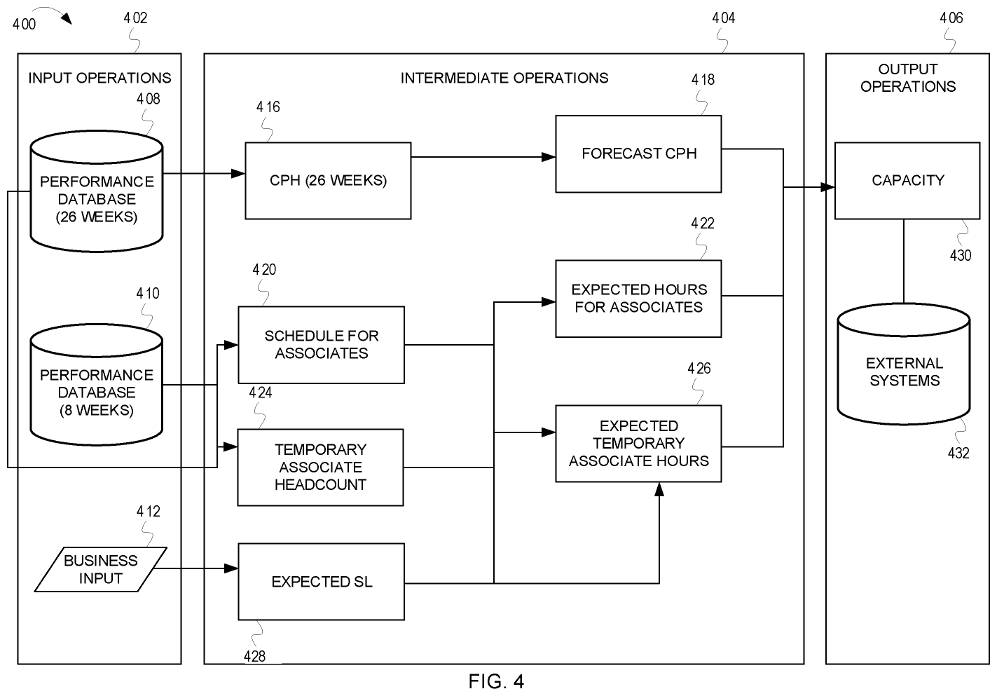

While the discussion of FIG. 3 describes example operations for calculating the capacity of a distribution center, the discussion of FIG. 4 describes a data flow for a capacity calculation.

FIG. 4 depicts a capacity calculation data flow 400, according to some embodiments. The data flow 400 incudes input operations 402, intermediate operations 404, and output operations 406. The input operations 402 include inputs from multiple sources. Specifically, the input operations 402 include inputs from a first performance database 408, a second performance database 410, and business inputs 412. That is, data are being supplied by the multiple sources for the intermediate operations 404. It should be noted, however, that though the first performance database 408, second performance database 410, and business inputs 412 are depicted as separate devices and/or sources, in some embodiments, the data may be supplied from a single input system and/or performance database. As depicted in FIG. 4, the first performance database 408 is providing data for the past twenty-six weeks for a CPH value calculation and an HC value calculation, the second performance database 410 is providing data for the past eight weeks for the HC value calculation, and the business inputs 412 is providing an SL value. The data provided by the input operations are used during the intermediate operations 404.

The intermediate operations 404 can include data analysis operations as well as intermediate calculations. For example, the intermediate operations 404 can include the calculation of values that will be used to ultimately calculate the capacity. As depicted in the example shown in FIG. 4, the intermediate operations include the calculation of the CPH value and HC value, as well as the data analysis for the determination of the SL value. With regard to the CPH value, first a historic CPH value 416 (i.e., a CPH value for the previous twenty-six weeks, as depicted in the example in FIG. 4) is calculated. Next, with regard to the CPH value, a forecast CPH value 418 is calculated. For example, the forecast CPH value 418 value can be calculated based on a time series forecasting method, such as exponential smoothing, and the historic CPH value 416. With regard to the HC value, both associates and temporary associated are considered. As shown in the example depicted in FIG. 4, the HC value calculation of the intermediate operations 404 considers the schedule for the associates 420 and the temporary associate headcount 424. These data are used in concert with the excepted SL 428 to calculate the expected hours for associates 422 and the expected temporary associate hours 426.

The output operations 406 include a calculation of the capacity 430 of the distribution center as well as any desired post-calculation steps. The capacity 430 of the distribution center is calculated based on the CPH value, the HC value, and the SL value. In some embodiments, the capacity 430 is published to externals systems 432.

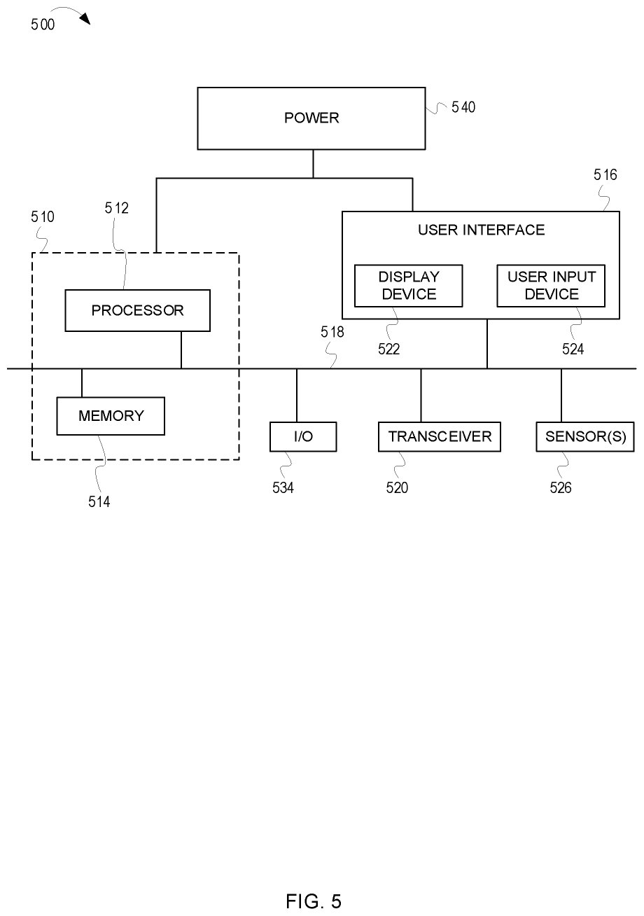

While the discussion of FIG. 4 describes a data flow for a capacity calculation, the discussion of FIG. 5 provides additional information regarding the systems disclosed herein.

FIG. 5 is a block diagram of a system 500 that may be used for implementing any of the components, circuits, circuitry, systems, functionality, apparatuses, processes, or devices of the system 200 of FIG. 2, and/or other above or below mentioned systems or devices, or parts of such circuits, circuitry, functionality, systems, apparatuses, processes, or devices. The circuits, circuitry, systems, devices, processes, methods, techniques, functionality, services, servers, sources and the like described herein may be utilized, implemented and/or run on many different types of devices and/or systems. For example, the system 500 may be used to implement some or all of the control circuit, the performance database, the input systems, the external systems, the mobile devices, one or more of the databases, and/or other such components, circuitry, functionality and/or devices. However, the use of the system 500 or any portion thereof is certainly not required.

By way of example, the system 500 may comprise a control circuit or processor (generally referred to as a “control circuit” 512), memory 514, and one or more communication links, paths, buses or the like 518. Some embodiments may include one or more user interfaces 516, and/or one or more internal and/or external power sources or supplies 540. The control circuit 512 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 512 can be part of control circuitry and/or a control system 510, which may be implemented through one or more processors with access to one or more memory 514 that can store commands, instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 500 may be used to implement one or more of the above or below, or parts of, components, circuits, systems, processes and the like.

The user interface 516 can allow a user to interact with the system 500 and receive information through the system. In some instances, the user interface 516 includes a display device 522 and/or one or more user input device 524, such as buttons, touch screen, track ball, keyboard, mouse, etc., which can be part of or wired or wirelessly coupled with the system 500. Typically, the system 500 further includes one or more communication interfaces, ports, transceivers 520 and the like allowing the system 500 to communicate over a communication bus, a distributed computer and/or communication network 114 (e.g., a local area network (LAN), wide area network (WAN) such as the Internet, etc.), communication link 518, other networks or communication channels with other devices and/or other such communications or combination of two or more of such communication methods. Further the transceiver 520 can be configured for wired, wireless, optical, fiber optical cable, satellite, or other such communication configurations or combinations of two or more of such communications. Some embodiments include one or more input/output (I/O) ports 534 that allow one or more devices to couple with the system 500. The I/O ports can be substantially any relevant port or combinations of ports, such as but not limited to USB, Ethernet, or other such ports. The I/O ports 534 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 526 to provide information to the system and/or sensor information that is communicated to another component, such as the central control system, a delivery vehicle, etc. The sensors can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, imaging system and/or camera, other such sensors or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The system 500 comprises an example of a control and/or processor-based system with the control circuit 512. Again, the control circuit 512 can be implemented through one or more processors, controllers, central processing units, logic, software and the like. Further, in some implementations the control circuit 512 may provide multiprocessor functionality.

The memory 514, which can be accessed by the control circuit 512, typically includes one or more processor-readable and/or computer-readable media accessed by at least the control circuit 512, and can include volatile and/or nonvolatile media, such as RAM, ROM, EEPROM, flash memory and/or other memory technology. Further, the memory 514 is shown as internal to the control system 510; however, the memory 514 can be internal, external or a combination of internal and external memory. Similarly, some or all of the memory 514 can be internal, external or a combination of internal and external memory of the control circuit 512. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over a computer network. The memory 514 can store code, software, executables, scripts, data, content, lists, programming, programs, log or history data, user information, customer information, product information, and the like. While FIG. 5 illustrates the various components being coupled together via a bus, it is understood that the various components may actually be coupled to the control circuit and/or one or more other components directly.

In some embodiments, a system for calculating a capacity of a distribution center comprises input systems, wherein the input systems collect metrics for the distribution center, a performance database coupled to the input systems, wherein the performance database includes the metrics for the distribution center, and a control circuit, wherein the control circuit is communicatively coupled to the performance database, and wherein the control circuit is configured to receive, from the performance database, the metrics for the distribution center, calculate, based on the metrics for the distribution center, a cases per hour (CPH) value for the distribution center, wherein the CPH value is indicative of a number of cases that is historically handled by the distribution center, determine, based on the metrics for the distribution center, a shift length (SL) value for the distribution center, wherein the SL value is indicative of a number of hours that employees work at the distribution center, calculate, based on the metrics for the distribution center, a head count (HC) value for the distribution center, wherein the HC value is indicative of a number of employees working at the distribution center, calculate, based on the CPH value, SL value and HC value, the capacity of the distribution center, wherein the capacity of the distribution center is a volume that the distribution center is capable of handling, and publish, to an external system, the capacity of the distribution center.

In some embodiments, an apparatus and a corresponding method performed by the apparatus comprises collecting, by input systems, metrics for the distribution center, storing, by a performance database, the metrics for the distribution center, receiving, by a control circuit from the performance database, the metrics for the distribution center, calculating, by the control circuit based on the metrics for the distribution center, a cases per hour (CPH) value for the distribution center, wherein the CPH value is indicative of a number of cases that is historically handled by the distribution center, determining, by the control circuit based on the metrics for the distribution center, a shift length (SL) value for the distribution center, wherein the SL value is indicative of a number of hours that employees work at the distribution center, calculating, by the control circuit based on the metrics for the distribution center, a head count (HC) value for the distribution center, wherein the HC value is indicative of a number of employees working at the distribution center, calculating, by the control circuit based on the CPH value, SL value and HC value, the capacity of the distribution center, and publishing, by the control circuit to an external system, the capacity of the distribution center.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system for calculating a capacity of a distribution center, the system comprising:
input systems, wherein the input systems collect a large data set comprising metrics for the distribution center;
a performance database coupled to the input systems, wherein the performance database includes the large data set comprising metrics for the distribution center; and
a control circuit, wherein the control circuit is communicatively coupled to the performance database, and wherein the control circuit is configured to:
receive, from the performance database, the large data set comprising metrics for the distribution center;
calculate, based on the large data set comprising metrics for the distribution center, a cases per hour (CPH) value for the distribution center, wherein the CPH value is indicative of a number of cases that is historically handled by the distribution center;
determine, based on the large data set comprising metrics for the distribution center, a shift length (SL) value for the distribution center, wherein the SL value is indicative of a number of hours that employees work at the distribution center;
calculate, based on the large data set comprising metrics for the distribution center, a head count (HC) value for the distribution center, wherein the HC value is indicative of a number of employees working at the distribution center;
calculate, based on the CPH value, SL value and HC value, the capacity of the distribution center, wherein the capacity of the distribution center is a volume that the distribution center is capable of handling; and
publish, to an external system, the capacity of the distribution center.

2. The system of claim 1, wherein the CPH value, SL value, and HC value are based on historical data.

3. The system of claim 1, wherein the CPH value, the SL value, and the HC value are averages of a previous time period.

4. The system of claim 3, wherein the period of time is one or more of weeks, months, and years.

5. The system of claim 3, wherein the time period is one of four weeks, one month, six weeks, thirteen weeks, twenty six weeks, and fifty two weeks.

6. The system of claim 1, wherein the HC value includes all employees assigned to the distribution center and all employee working at the distribution center that are assigned to different distribution centers.

7. The system of claim 1, wherein the capacity of the distribution center is calculated based on a formula, and wherein the formula is:
Capacity=CPH value×SL value×HC value.

8. The system of claim 1, wherein the capacity of the distribution center is a number of cases.

9. The system of claim 1, wherein the metrics for the distribution center include one or more of cases, clock hours, total hours, and employee numbers.

10. The system of claim 1, wherein the control circuit is further configured to:
receive an anticipated demand;
determine, based on the anticipated demand and the capacity of the distribution center, that the anticipated demand cannot be met; and
cause transmission of a notification, wherein the notification indicates that the anticipated demand cannot be met.

11. A method for calculating a capacity of a distribution center, the method comprising:
collecting, by input systems, a large data set comprising metrics for the distribution center;
storing, by a performance database, the large data set comprising metrics for the distribution center;
receiving, by a control circuit from the performance database, the large data set comprising metrics for the distribution center;
calculating, by the control circuit based on the large data set comprising metrics for the distribution center, a cases per hour (CPH) value for the distribution center, wherein the CPH value is indicative of a number of cases that is historically handled by the distribution center;
determining, by the control circuit based on the large data set comprising metrics for the distribution center, a shift length (SL) value for the distribution center, wherein the SL value if indicative of a number of hours that employees work at the distribution center;
calculating, by the control circuit based on the large data set comprising metrics for the distribution center, a head count (HC) value for the distribution center, wherein the HC value is indicative of a number of employees working at the distribution center;
calculating, by the control circuit based on the CPH value, SL value and HC value, the capacity of the distribution center; and
publishing, by the control circuit to an external system, the capacity of the distribution center.

12. The method of claim 11, wherein the CPH value, SL value, and HC value are based on historical data.

13. The method of claim 11, wherein the CPH value, the SL value, and the HC value are averages of a previous time period.

14. The method of claim 13, wherein the time period is one or more of weeks, months, and years.

15. The method of claim 13, wherein the time period is one of four weeks, one month, six weeks, thirteen weeks, twenty six weeks, and fifty two weeks.

16. The method of claim 11, wherein the HC value includes all employees assigned to the distribution center and all employee working at the distribution center that are assigned to different distribution centers.

17. The method of claim 11, wherein the capacity of the distribution center is calculated based on a formula, and wherein the formula is:
Capacity=CPH value×SL value×HC value.

18. The method of claim 11, wherein the capacity of the distribution center is a number of cases.

19. The method of claim 11, wherein the metrics for the distribution center include one or more of cases, clock hours, total hours, and employee numbers.

20. The method of claim 11, further comprising:
receiving, by the control circuit, an anticipated demand;
determining, by the control circuit based on the anticipated demand and the capacity of the distribution center, that the anticipated demand cannot be met; and
causing transmission, by the control circuit, of a notification, wherein the notification indicates that the anticipated demand cannot be met.
